(19) United States
(12) Patent Application Publication
(10) Pub. No.: US 2012/0126612 A1
(43) Pub. Date: May 24, 2012

(54) AC-DC POWER SUPPLY UNIT AND ASSOCIATED DEVICE

(75) Inventors: Jonathan Ephraim David Hurwitz, Edinburgh (GB); Iain Barnett, Lasswade (GB)

(73) Assignee: BROADCOM CORPORATION, IRVINE, CA (US)

(21) Appl. No.: 13/300,031

(22) Filed: Nov. 18, 2011

(30) Foreign Application Priority Data
Nov. 23, 2010 (GB) 1019819.0

(51) Int. Cl. H04B 3/54

(52) U.S. Cl. 307/3

(57) ABSTRACT

An external power supply unit (PSU) for an appliance includes rectification circuitry operable to convert an AC voltage from mains power lines to a DC voltage output, decoupling circuitry operable to decouple a broadband data signal from the mains power lines, timing circuitry operable to provide a signal representative of the mains AC voltage timing, and conveyance circuitry operable to convey the DC voltage output, a ground reference signal, the signal representative of the mains AC voltage timing, and the broadband data signal to the appliance, wherein the conveyance circuitry has no more than four conductors. The timing circuitry may be further operable to modulate the signal representative of the mains AC voltage timing onto either the DC voltage output or the broadband data signal. The timing circuitry may be a zero-crossing detector.

### CROSS-REFERENCE TO PRIORITY APPLICATION

This application claims priority under 35 U.S.C. §119(a) to Great Britain Application Serial No. 1019819.0 filed Nov. 23, 2010, which is incorporated herein by reference in its entirety for all purposes.

### BACKGROUND OF THE INVENTION

1. Field of the Invention

The invention is in the field of communications over power lines or the like; and in particular it relates to power supply units for devices configured to communicate over power lines or the like.

2. Description of the Related Art

Powerline broadband modems are currently used for broadband communications using powerlines as the connecting medium, i.e., Powerline Communications network. The connection points for this network (electrical sockets) are commonly found to contain a large collection of electrical equipment (for example, a media center in a living room). For reasons such as safety and noise reduction it is usual to provide a relatively low (safe) voltage external power supply unit providing a DC supply to power, from the mains AC supply, many types of appliances. Where such an appliance is of a type configured to receive broadband data via the same power line as the mains electricity system, the appliance may comprise circuits for decoupling digitally encoded signals from the AC voltages of the power line and/or for injecting digitally encoded signals into the power line. Therefore the appliance requires direct connection to the AC mains supply for such data communication. In addition, such a device may require a representation of the AC mains zero-crossing points (for timing etc.). This would suggest a need for a cable between the power supply unit and the appliance requiring at least six lines, two for the DC power, two for the zero crossing signal, and two for the communications. The resultant six-wire cable would be stiff, bulky, and unwieldy and the connection required would be larger than ideal.

### BRIEF DESCRIPTION OF THE DRAWINGS

Embodiments of the invention will now be described, by way of example only, by reference to the accompanying drawings, in which:

FIG. 1 illustrates a power supply unit including at least part of a communication interface;

FIG. 2 illustrates another power supply unit including at least part of a communication interface;

FIG. 3 illustrates a power supply unit including at least part of a communication interface and two wire output according to an embodiment of the invention, with input interfacing for an accompanying appliance constructed according to one or more embodiments of the present invention;

FIGS. 4A and 4B illustrate a more specific embodiment of the power supply unit of FIG. 3;

FIG. 5 illustrates input, output, and one intermediary signal of the circuit of FIGS. 4A and 4B;

FIGS. 6A and 6B illustrate a further specific embodiment of the power supply unit of FIG. 3;

FIG. 7 illustrates an alternative arrangement to that depicted in FIG. 3, whereby modulation is performed using frequency shift keying techniques;

FIG. 8 illustrates a further embodiment of the invention whereby the zero-crossing signal is modulated on to the common mode voltage of the broadband signal;

FIG. 9 illustrates an alternative to the arrangement of FIG. 8 whereby the zero-crossing signal is modulated on to the common mode current of the broadband signal;

FIG. 10 illustrates a three wire variation of the arrangement of FIG. 8;

FIG. 11 illustrates a further alternative to the arrangement of FIG. 8 whereby modulation is performed using frequency shift keying techniques; and

FIG. 12 illustrates an embodiment whereby a DC output and GND of AC-DC module is conveyed on a pair of wires and zero-crossing signal and broadband signal are carried on a third wire using GND as reference.

### DETAILED DESCRIPTION OF THE EMBODIMENTS

The present invention may be embodied in various forms. One embodiment of the present invention is as an external Power Supply Unit (PSU) for an appliance that includes rectification circuitry operable to converting an AC voltage from mains power lines to at least one DC voltage, decoupling circuitry operable to decoupling broadband data signal from said mains power lines, timing circuitry operable to providing a signal representative of the mains AC voltage timing, and conveyance circuitry operable to conveying the DC voltage output, ground reference signal, signal representative of the mains AC voltage timing and a broadband data signal to said appliance. In this embodiment, the conveyance circuitry has no more than four conductors.

The PSU may be operable to modulate the signal representative of the mains AC voltage timing onto either the DC voltage output or the broadband data signal. The circuitry operable to providing a signal representative of the mains AC voltage timing may include a zero-crossing detector. The PSU may further include circuitry operable to modulating the DC voltage output with the signal representative of the mains AC voltage timing. The PSU may be operable such that the DC voltage output, the ground reference and the signal representative of the mains AC voltage timing are output on a single pair of conductors included within the conveyance circuitry. The modulating of the DC output may include causing the DC output to ripple between two levels at a frequency dependent on the signal representative of the mains AC voltage timing.

In one embodiment, the conveyance circuitry includes a total of one pair of conductors, the power supply unit being operable to carry the broadband data signal, the modulated DC output, and the ground reference on the one pair of conductors. The power supply unit may further include filtering circuitry operable to remove noise and/or raise the output impedance of the circuitry operable to converting a mains AC voltage to at least one DC voltage, to allow the injection of the broadband data signal on the same pair of conductors as those operable to carry the modulated DC output and ground reference. The conveyance circuitry may terminate with a conventional coaxial DC connector.

Alternatively the conveyance circuitry may include a total of two pairs of conductors, the power supply unit being operable to carry the broadband data signal on an additional pair of conductors. The PSU may be operable such that the modulated DC voltage output is conveyed by modulation of the common mode voltage, or current, of the broadband data signal, on a pair of conductors included within the conveyance circuitry, a third conductor being operable to carry the ground reference, the conveyance circuitry including a total of three conductors.

The PSU may be operable such that the signal representative of the mains AC voltage timing is arranged to control an oscillator at a rate dependent on the frequency of the zero-crossing of its input signal to modulate the DC signal. The modulation may be arranged to employ feedback modulation, where the oscillator's reference signal is obtained from the modulated DC output signal. Alternatively, the oscillator may use a fixed reference, and feed an error amplifier operable to output an error signal for appropriate control of the duty cycle of the circuitry operable to converting a mains AC voltage to at least one DC voltage so as to modulate the DC output.

As a further alternative to those described above, the PSU may be operable such that the signal representative of the mains AC voltage timing is conveyed by modulation of the common mode voltage, or current, of the broadband data signal on a pair of conductors included within the conveyance circuitry, the conveyance circuitry including a total of four conductors, the other two conductors being operable to convey the DC voltage output and ground reference signal. As an alternative, the signal representative of the mains AC voltage timing may be conveyed by modulation of the differential mode of the broadband data signal, e.g. by using FSK techniques.

In a further aspect of the present invention there is provided an appliance requiring a DC power supply for operation, and further including a power line communication modem for modulation and demodulation of broadband data signal onto mains electrical powerlines, the modem requiring a mains timing signal for proper operation. The appliance includes a two or three-line input for receiving input signals conveyed thereto on two, or three conductors. The appliance is operable such that the input signals include the DC power supply, the broadband data signal, and the mains timing signal. The appliance includes circuitry operable to obtaining the mains timing signal and low pass filtering circuitry operable to separating the DC component of the signal for supply of the power. The appliance may include a two-line input and further include high pass filtering circuitry and circuitry, such as a signal transformer, for decoupling of broadband data signal received on the input. The circuitry operable to obtaining the mains timing signal may include a band pass filter. The appliance may include a three-line input, the circuitry operable to obtaining the mains timing signal may include a divider circuit connected between two lines of the three line input, the two lines carrying the broadband data signal. In a further aspect of the invention there is provided a package including a power supply unit of the first aspect of the invention and an appliance of the second aspect of the invention.

A method of conveying a DC voltage output and ground reference signal, a signal representative of the mains AC voltage timing and broadband data signal over no more than four conductors includes first modulating the signal representative of the mains AC voltage timing onto either the DC voltage output or the broadband data signal. The method may be performed using three conductors, the modulated DC component of the DC voltage output also being carried as common mode signal offset on the pair of conductors carrying the broadband data signal, the third conductor carrying the ground reference. The method may include modulating the DC voltage output with the signal representative of the mains AC voltage timing prior to carrying the modulated DC signal and a ground reference on a first pair of conductors. The method may include coupling the broadband signal to the first pair of conductors, thereby performing the method using only two conductors. Alternatively, the method may include using four conductors, with the broadband signal being carried on a second pair of conductors.

Alternatively, the signal representative of the mains AC voltage timing may be modulated as a common mode signal, or a differential mode signal, on the pair of conductors carrying the broadband data signal. The method may be performed using four conductors, the other two conductors being used to carry the DC voltage output and ground reference signal.

For reasons such as safety and noise reduction it is usual to provide a relatively low (safe) voltage DC supply to power many types of appliances such as, for example, a computing device, telephone, audio device, video device, wireless device/router, printer, laptop computer, television, stereo, music storage device, audio amplifier, speaker, and/or the like. This is preferably provided by an external AC/DC converter (power supply unit—PSU) which is powered by the mains electricity system and provides a lower voltage DC output. However, where the appliance is configured to receive broadband data via the same power line as the mains electricity system, it typically includes circuits configured to decouple digitally encoded signals from the AC voltages of a power line and/or configured to inject digitally encoded signals into the power line. Therefore the appliance requires direct connection to the AC mains supply.

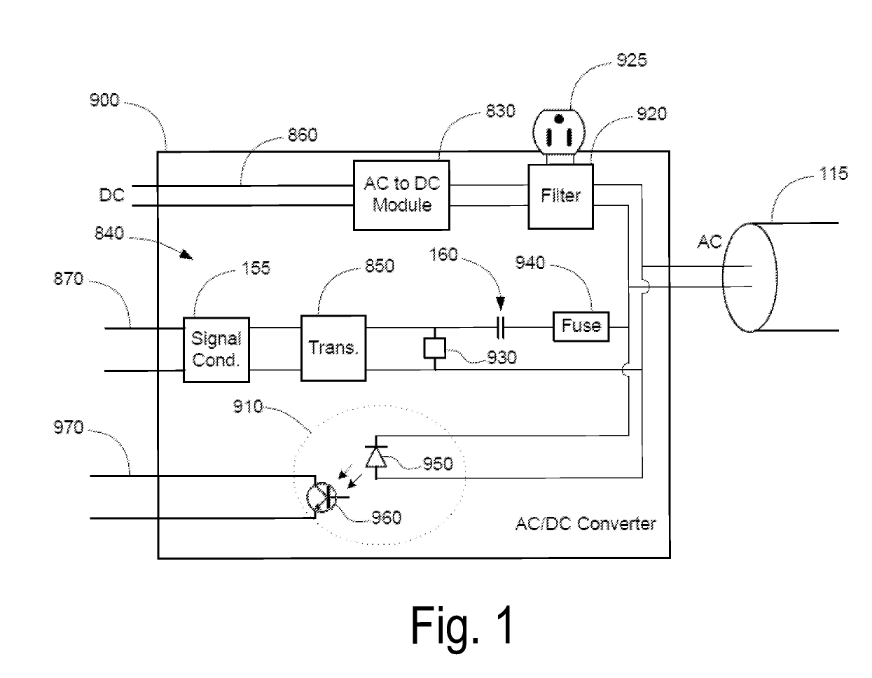

FIG. 1 illustrates a power supply unit including at least part of a communication interface. The power supply unit 900 is made up of three main elements, an AC to DC module 830, signal coupling circuitry 840 and zero crossing circuitry 910. While power supply unit 900 can be integral with an appliance, in this example power supply unit 900 is external to, and/or detachable from, an appliance, e.g., personal computer, router, laptop computer, tablet computer, cell phone, etc. The appliance for which the power supply unit 900 is designed may include a power line communication (PLC) modem configured to send and receive digitally encoded signals. The power line modem typically includes data transmission (TX) circuits for transmitting digitally encoded signals, and data reception (RX) circuits for receiving digitally encoded signals, as is known in the art. Such an appliance can also include at least some of the active and/or passive components of a communication interface.

The AC to DC module 830 is configured to convert the AC line voltage of a power line 115 to one or more DC voltages (e.g., +/−5 v, +/−9 v, +/−12 v, or the like) on one or more conductors 860. The power supply unit 900 may also include an optional filter 920 in electrical communication between AC to DC module 830 and the power line 115, or between AC to DC module 830 and signal coupling circuitry 840. The filter 920 is configured to protect other components of power supply unit 900 from electrical noise generated by AC to DC module 830. Filter 920 can be a low-pass filter, for example. The filter 920 can also couple an external AC socket 925 to the power line 115. The filter 920 can then also serve to remove noise generated by any appliances attached to AC socket 925. A further filter may also be provided on the output side of the AC to DC module 830.

As noted, power supply unit 900 also includes signal coupling circuitry 840 in electrical communication with power line 115 and configured to send and receive digitally encoded signals over one or more conductors 870. Signal coupling circuitry 840 includes the transformer 850 and can optionally also include one or more of, all of, any combination of, or part(s) of: coupling capacitor 160, signal conditioner 155, an over-voltage protection device 930, and a fuse 940. Signal coupling circuitry 840 may include an entire communication interface or merely a part thereof with the remaining part of the communication interface optionally residing in the appliance attached thereto.

Zero crossing circuitry 910 includes, in this example, a LED (light-emitting diode) 950 and an adjacent photo detector 960. In the zero crossing circuitry 910, the LED 950 is in electrical communication with power line 115 and is configured to emit light pulses that are synchronized to the waveform of the AC line voltage. Photo detector 960 receives the light pulses and produces a timing signal that can be communicated over one or more conductors 970 to an appliance.

Power supply unit 900 is connected to an appliance by cabling 860, 870, and 970. Cabling provides communication between an appliance and power supply unit 900. Cabling may be integral with power supply unit 900. The cabling may include one or more conductors 860 (typically two) configured to convey the one or more DC voltages between power supply unit 900 and the appliance, one or more conductors 870 (typically two) configured to convey the digitally encoded signals between an appliance and power supply unit 900 and one or more conductors (typically two) for communicating the timing signal from the zero-crossing circuitry 910. Therefore there are typically six output conductors from the AC/DC converter. Where the power supply unit 900 is detachable from an appliance, the conductors 860, 870, 970 may be wrapped together by a common insulation layer, or else each may be insulated separately from the other conductors. Conductors 870 are optionally rated for the digitally encoded signals but not rated for voltages as high as the AC voltages found on the power line.

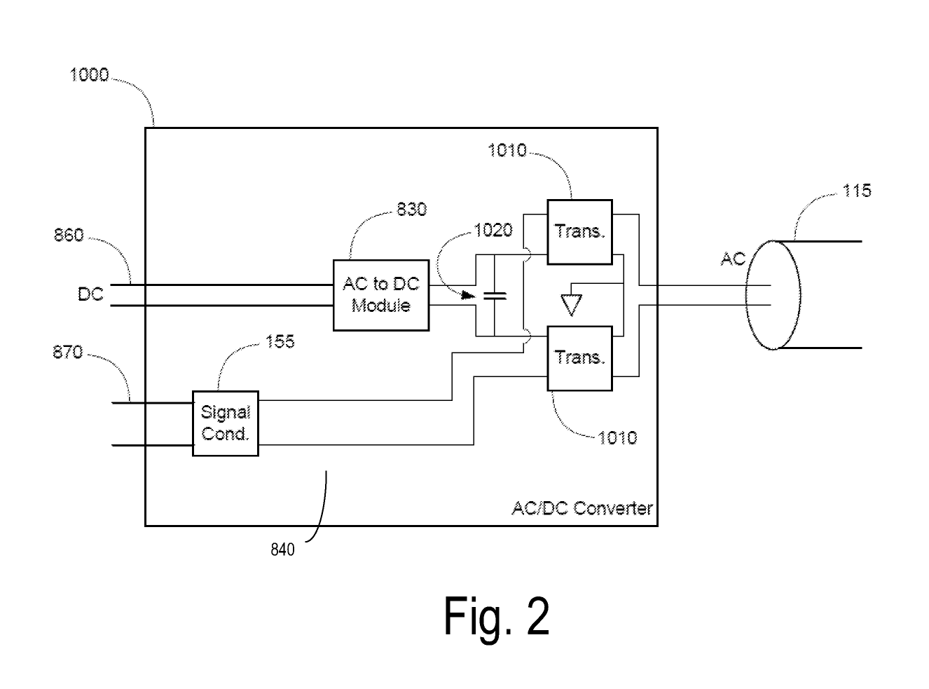

FIG. 2 illustrates another power supply unit including at least part of a communication interface. The power supply unit 1000 includes AC to DC module 830, signal coupling circuitry 840, and zero crossing circuitry 910 (not shown for clarity). Signal coupling circuitry 840 is configured to send and receive digitally encoded signals between one or more conductors 870 and the power line 115. Signal coupling circuitry 840, in the illustrated example, includes a pair of transformers 1010 in parallel electrical communication between the power line 115 and a common ground as shown. The pair of transformers 1010 may be replaced by a single multi-tap transformer. The pair of transformers 1010 may serve the functions of transformer 850. Signal coupling circuitry 840 optionally also includes one or more of, any combination of, or all of a signal conditioner 155, a coupling capacitor (not shown), an over-voltage protection device (not shown), and a fuse (not shown). As in the example described with respect to FIG. 1, signal coupling circuitry 840 may include an entire communication interface or merely a part thereof with the remaining part of the communication interface optionally residing in an appliance.

AC to DC module 830 of the example illustrated by FIG. 2 receives AC line voltage from power line 115 through the pair of transformers 1010, as shown, and outputs one or more DC voltages on one or more conductors 860. A filter such as capacitor 1020 may be disposed between the pair of transformers 1010 and AC to DC module 830 to protect other components of power supply unit 1000 from electrical noise generated by AC to DC module 830.

Conductors 860 and 870, and 970 (not shown), together can include cabling. Cabling can be integral with, or detachable from, power supply unit 1000. Cabling can also terminate in a connector configured to mate with a corresponding receptacle on an appliance (not shown).

However such a connector would have to be larger than a conventional two-wire DC power connection, and the resultant cable needs to be larger and stiffer than a two-wire cable. This is not desirable, and it would be preferable if a standard two wire output PSU with conventional connector could be used in the situations discussed above.

Such a PSU should include:
Circuitry to detect and modulate the phase of AC mains frequency onto the two wires containing the ‘DC Power’
Circuitry to couple the broadband PLC signal to/from the AC wires to the two wires containing the ‘DC Power’
Circuitry to prevent the broadband PLC signal being ‘absorbed’ by the impedance of the AC-DC PSU or drowned out by the noise of the AC-DC PSU

Furthermore, the appliance should further include:
Circuitry to detect and de-modulate the phase of AC mains that has been put on to the two wires containing the ‘DC Power’
Circuitry to couple the PLC signal to/from the two wires containing the ‘DC Power’ from the PLC modem
Circuitry to prevent the PLC signal being ‘absorbed’ by the impedance of the internal DC-DC PSU or drowned out by the noise of the internal DC-DC PSU

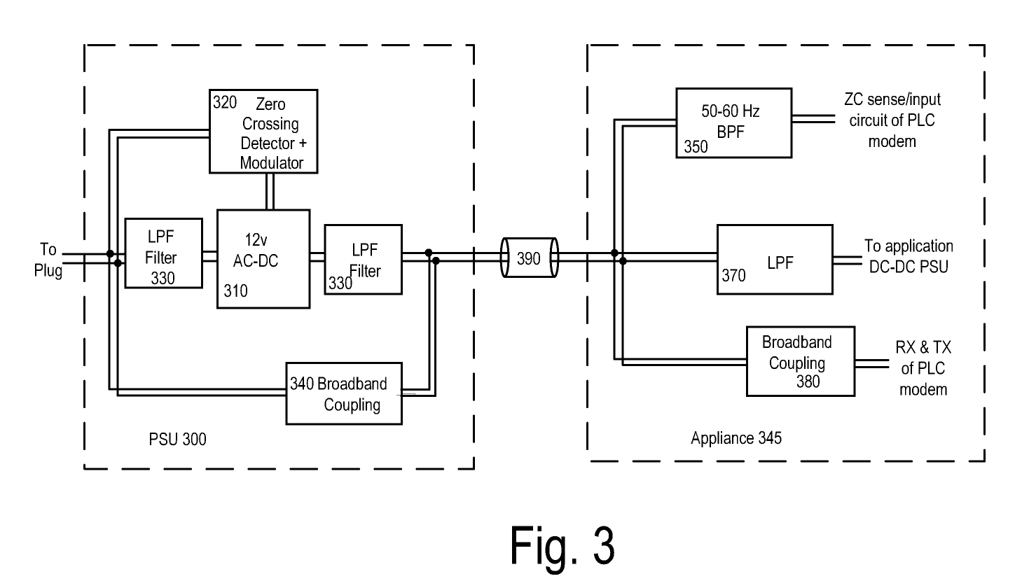

FIG. 3 illustrates a power supply unit including at least part of a communication interface and two wire output according to an embodiment of the invention, with input interfacing for an accompanying appliance constructed according to one or more embodiments of the present invention. Provided is a PSU 300 having an AC-DC module 310, a zero crossing detector and modulator 320 which modulates the output of the AC-DC module 310, low pass filters 330 and a high frequency signal transformer 340 all arranged as shown.

PSU 300 operates by using the zero crossing detector and modulator 320 to modulate the zero-crossing signal, which represents the mains timing of the input AC voltage, onto the DC output of the AC-DC module 310. This modulated DC output is then passed through filter 330, on a single pair of wires 390. Broadband signals are then coupled to the same pair of wires.

The appliance 345 is adapted by being further provided (by way of input module, or otherwise) with a 50-60 Hz Band Pass Filter 350, for separating out the timing signal from the zero-crossing detector, a Low Pass Filter 370 for separating out the DC component, and a High Pass filter 380 and signal transformer (not shown) for handling the broadband data signals prior to sending the resultant data to the modem. The broadband data signal (or signals) is preferably spectrally contained within frequencies greater than 1 MHz (which could be in more than 1 band).

The power cable 390 in this embodiment is standard two-wire cable which can terminate in a standard DC connector. The two-wire cable carries DC power and ground, the broadband data signals, and a representation of the AC mains zero-crossing point, e.g. a modulation of the DC voltage synchronized to the AC mains frequency. Connection may be made with ferrites at each end to reduce radiation.

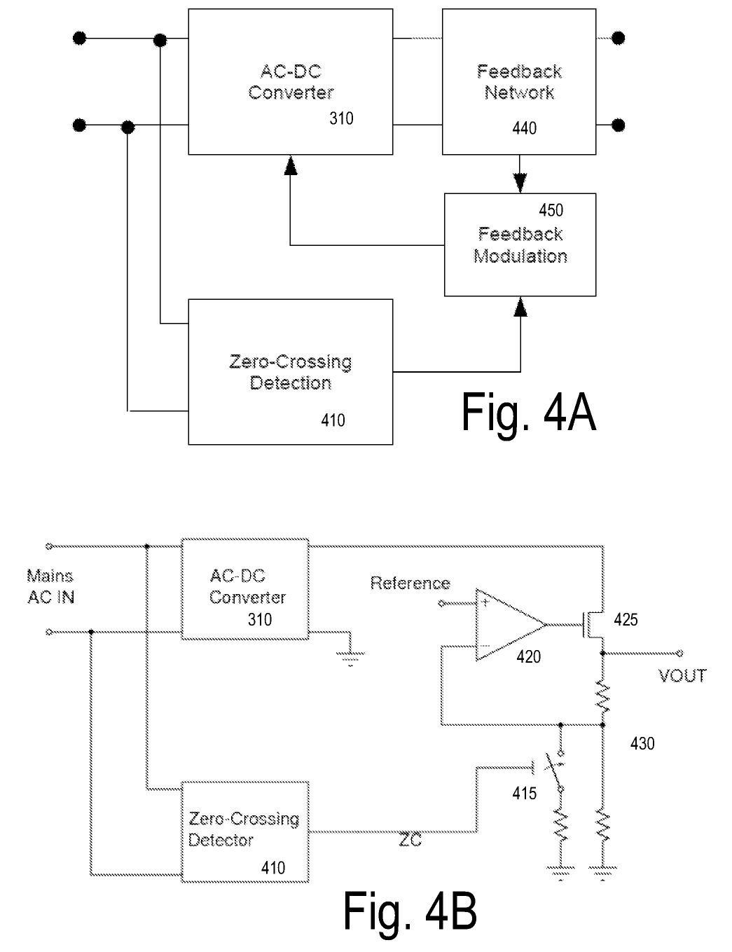

FIGS. 4A and 4B illustrate a more specific embodiment of the power supply unit of FIG. 3. FIG. 4A shows schematically a first arrangement of the AC-DC module 310 and zero crossing detector and modulator 320 of the PSU 300 of FIG. 3. This modulates the zero-crossing detection module's 410 output onto the output of the AC-DC converter module 310, using a feedback modulation 450 arrangement. FIG. 4A shows the AC-DC converter module 310, feedback network 440, feedback modulation 450, and zero-crossing detector 410 arranged as shown.

FIG. 4B shows an example of how the arrangement of FIG. 4A may be implemented. It includes the AC-DC converter module 310, zero-crossing detector module 410, switch 415, error amplifier 420, pass device 425, and resistors 430 arranged as shown. The error amplifier 420 feedback loop forces the negative input of the error amplifier 420 to be equal to the reference voltage present at its positive input. The switch 415 causes the resistance between this node and ground to vary, which in turn varies the current through the resistance. This sets the current through the (fixed) resistor between VOUT and the error amplifier's negative input (Held at a reference voltage), which in turn sets the voltage between VOUT and the reference voltage. Hence VOUT alternates between two values depending on the current drawn through the resistors (as set by the zero crossing detector).

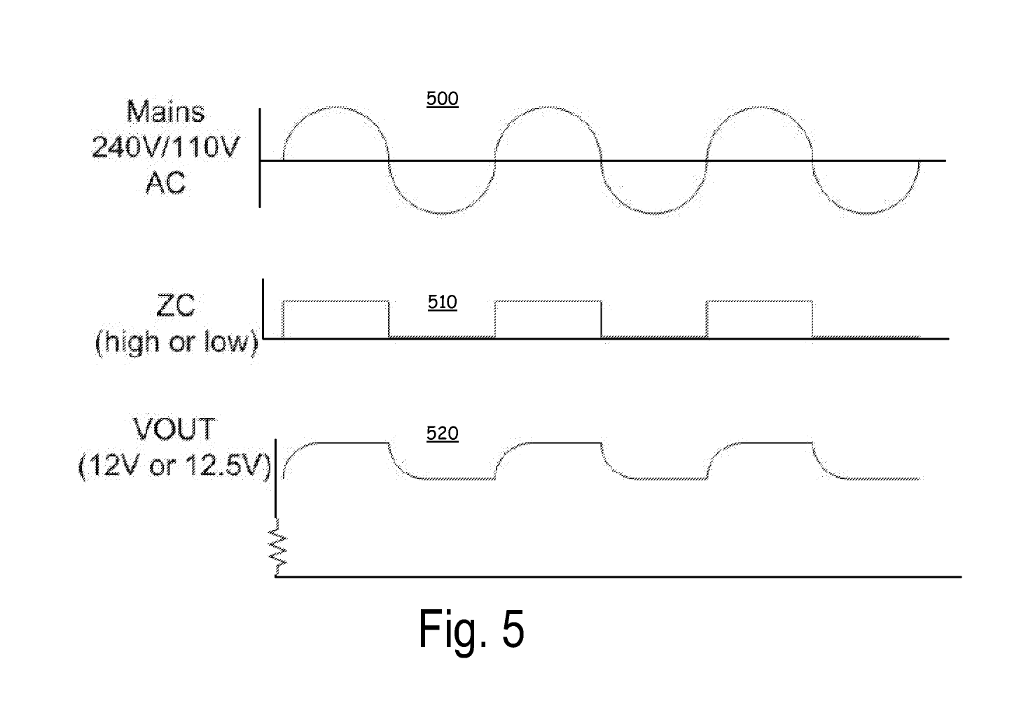

FIG. 5 illustrates input, output, and one intermediary signal of the circuit of FIGS. 4A and 4B, including wave traces (not to scale) for the mains input 500, the zero-crossing module output 510 and the output signal VOUT 520. As can be seen, the output signal VOUT 520 alternates between 12 and 12.5 v at the mains frequency (typically around 50 Hz). It is to this signal (possibly after further noise filtering), that the data signal from the signal transformer 340 is added.

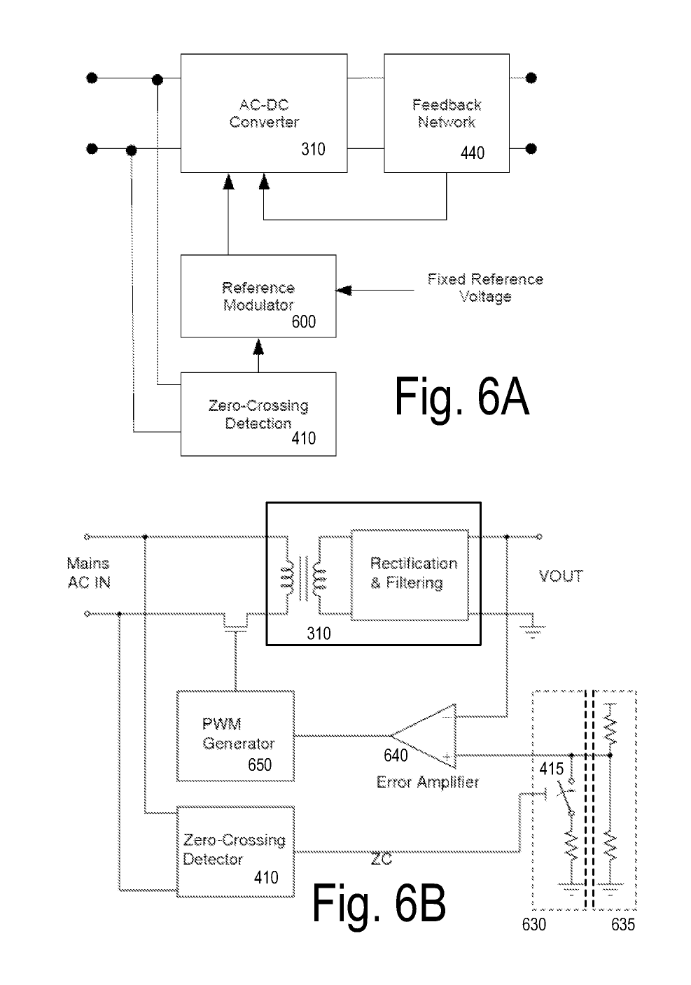

FIGS. 6A and 6B illustrate a further specific embodiment of the power supply unit of FIG. 3. FIG. 6A shows an alternative to the arrangement of the AC-DC module 310 and zero crossing detector and modulator 410, 450 as depicted in FIG. 4A. Instead of the feedback modulation of FIG. 4A, the structure of FIG. 6A uses a reference modulator 600, the feedback network 440 feeding back to the AC-DC converter module 310 by controlling its duty cycle so as to stabilize voltage.

FIG. 6B is an illustrative example of the arrangement of FIG. 6A. Again the Zero-crossing detector module's 410 output controls an switch 415, which this time forms part of a reference modulator 630. Reference modulator 630 has a fixed reference input from fixed reference voltage generator 635. In operation, the reference modulator 630 output alternates between two fixed values. These two fixed values are used as reference for error amplifier 640, its other input receiving output signal VOUT from the AC-DC module 310. The output of the error amplifier 640 (the error signal) feeds into the pulse width modulation (PWM) generator 650 where it is used as the reference or demand. The pulsed output of PWM generator 650, in turn controls a switch on the AC input, alternating the duty cycle such that the output alternates in a similar way to waveform 520 of FIG. 5.

An alternative to the two-wire solutions above are a four-wire solution, wherein the zero-crossing signal is modulated on the DC signal as described above, but with the broadband data carried on separate wires. This reduces the need for filtering the DC signal while still allowing use of low cost connectors (3.5 mm jacks, USB, RJ11 etc.). Another alternative to the two-wire solutions is a three-wire solution in which power and GND are carried by two wires and the broadband data and zero-crossing signal are superimposed on a third wire with respect to GND.

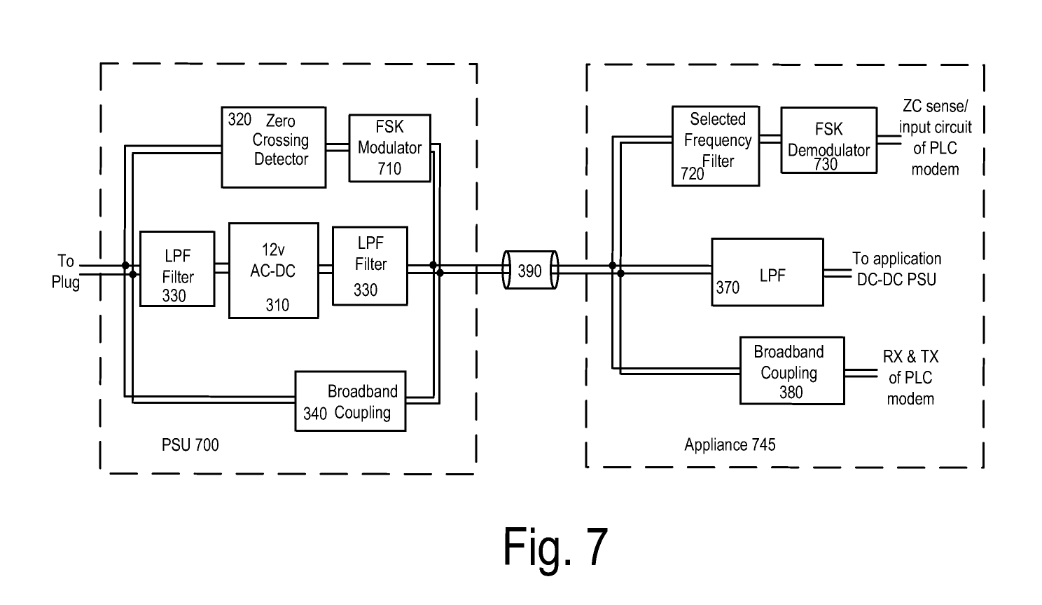

FIG. 7 illustrates an alternative arrangement to that depicted in FIG. 3, whereby modulation is performed using frequency shift keying techniques. Up to now, previous embodiments have used modulation techniques which employ level shifting of the DC or broadband signals. However the scope of the invention also covers other modulation techniques, for example frequency-shift keying (FSK). The difference in the PSU 700 is the inclusion of an FSK modulator 710, the output of which is added to the DC output lines, along with the broadband signals. Similarly appliance 745 is amended to include a selected frequency filter 720 and FSK demodulator 730 to obtain the zero-crossing signal from the appliance 745 input.

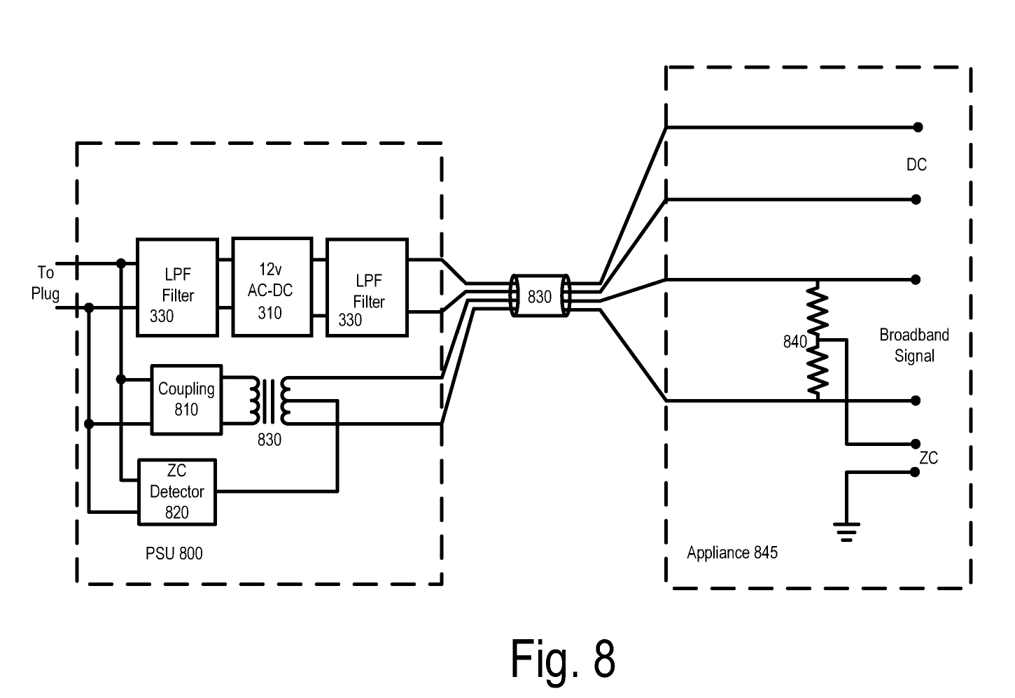

FIG. 8 shows a four wire cable 830 embodiment which operates by modulating the zero crossing signal onto the broadband signal's common mode voltage. The PSU 800 has broadband signal coupling circuitry 810 and isolating transformer 830. The zero crossing signal from the zero crossing detector 820 drives a coil tap on the secondary winding of the broadband signal isolating transformer 830, hence setting the broadband signal's common mode. In the appliance 845 the common mode signal is extracted by way of a potential divider 840 between the two signal lines.

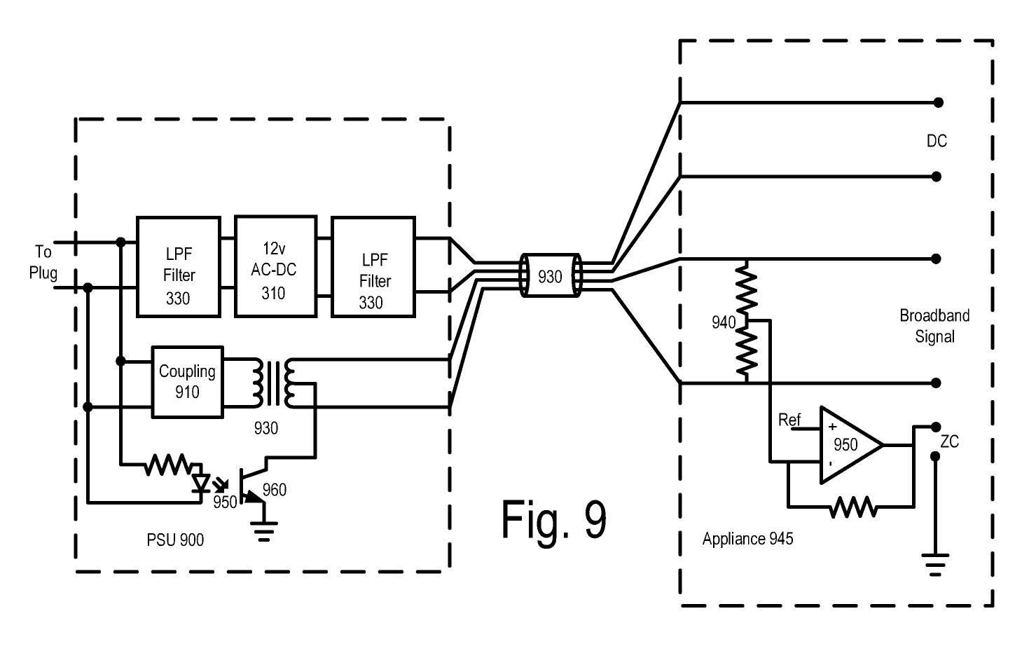

FIG. 9 illustrates an alternative to the arrangement of FIG. 8 whereby the zero-crossing signal is modulated on to the common mode current of the broadband signal. The common mode of the broadband signal is held at a fixed voltage by a sense amplifier 950 in the appliance 945 which receives one input from a potential divider 940 between the two signal lines. The coil tap of the secondary winding of the broadband signal isolating transformer 930 is connected to the collector of an optocoupler's 950 phototransistor 960. The AC mains waveform determines the current through the phototransistor 960 which causes a current at the input to the sense amplifier 950. Hence a voltage proportional to the rectified AC mains signal is produced at the output of the sense amplifier 950. Hence the zero-crossing signal can be transmitted by modulation of the common mode current.

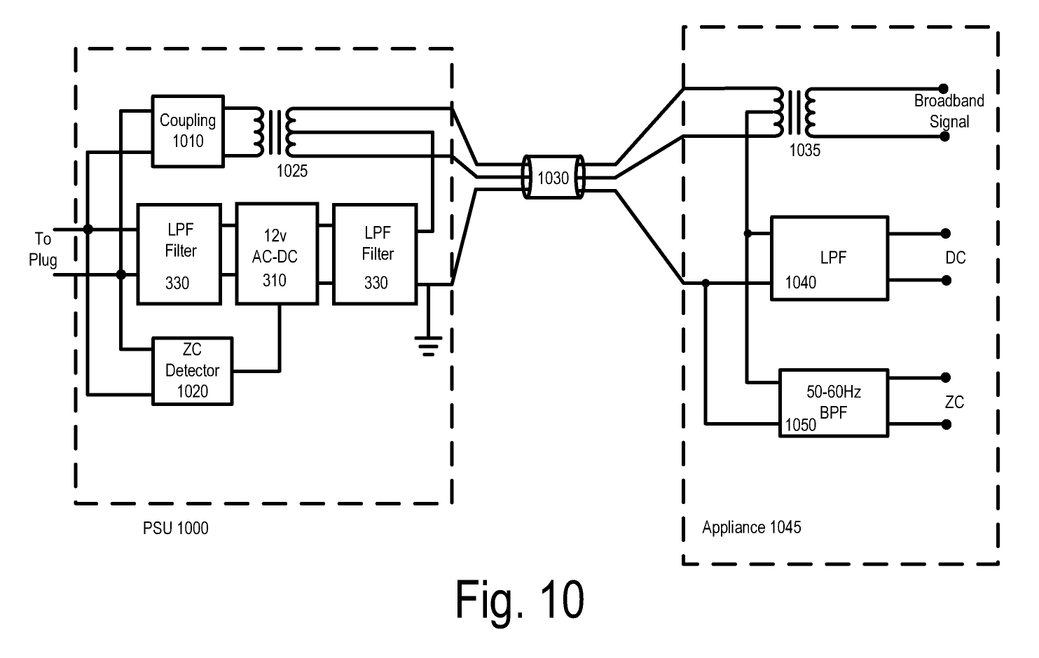

FIG. 10 shows a three wire cable 1030 embodiment which essentially employs the modulation techniques of the embodiments of FIG. 3 and FIG. 8 (or 9). The PSU 1000 has broadband signal coupling circuitry 1010 and transformer 1025. It operates by using the zero crossing detector and modulator 1020 to modulate the zero-crossing signal onto the DC output of the AC-DC module 310. This Modulated DC output then drives a coil tap on the secondary winding of the broadband signal transformer 1025, hence setting the broadband signal's common mode with the modulated DC output signal. This circuitry that the broadband signal wires are effectively conveying both the DC component and the zero crossing signal, the other wire including the ground reference.

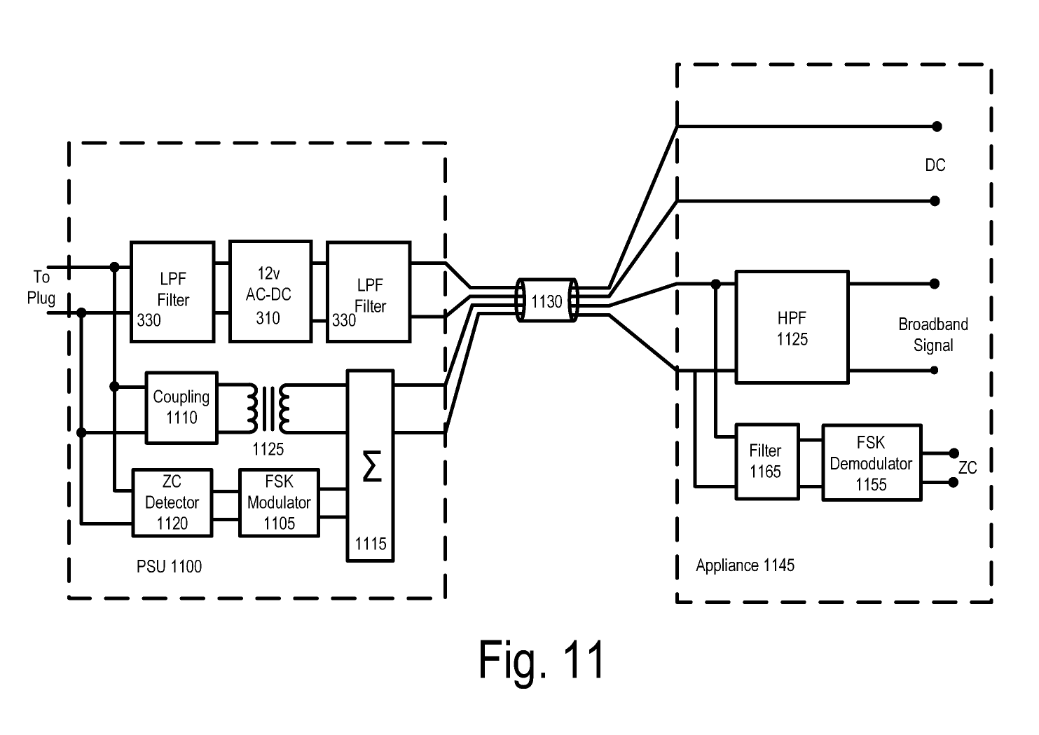

FIG. 11 shows yet another four wire cable 1130 embodiment which operates by modulating the zero crossing signal onto the broadband signal's differential mode, and like the FIG. 7 embodiment, employs FSK modulation. In this embodiment, the zero-crossing detector 1120 signal is fed to an FSK modulator 1105 (outside of the band of the broadband signal). The FSK modulated signal is then summed 1115 with the broadband signal produced by coupling 1110 and transformer 1125. Appliance 1145 has selected frequency filter 1165 and FSK demodulator 1155 to obtain the zero-crossing signal from the appliance input. High pass filter 1125 produces the broadband signal.

The above examples illustrate circuits configured to couple digitally encoded signals to and from a power line. Alternative embodiments may include other circuits configured to decouple a digitally encoded signal from a power line and/or to inject a digitally encoded signal into a power line. Examples of such circuits include those illustrated in US 2007-0075843 A1, filed Aug. 24, 2006.

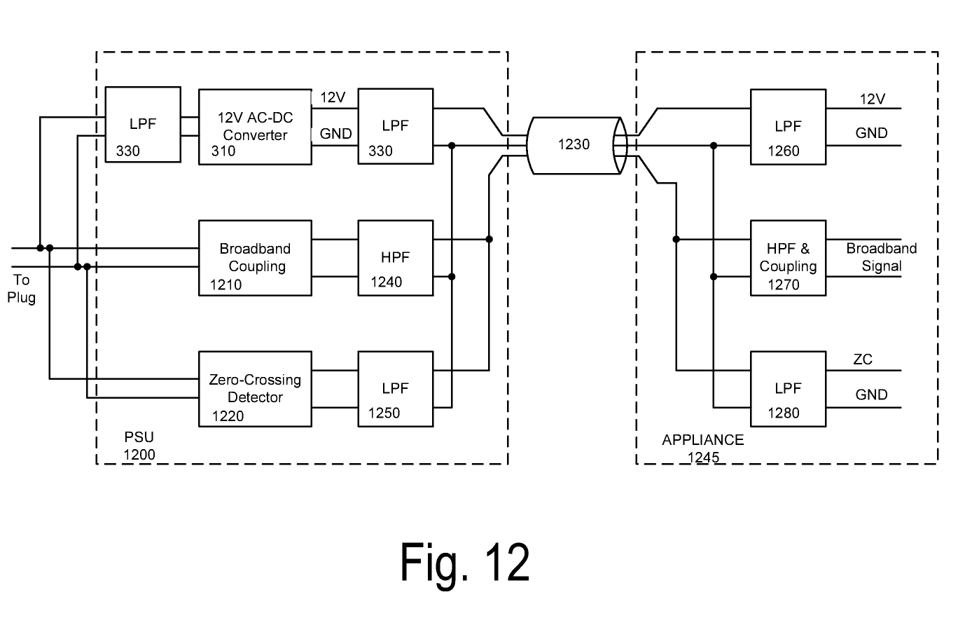

FIG. 12 illustrates an embodiment whereby a DC output and GND of AC-DC module 310 is conveyed on a pair of wires and zero-crossing signal and broadband signal are carried on a third wire of a three wire cable 1230 using GND as reference. The representation of the AC mains zero crossing point (zero crossing signal) produced by zero-crossing detector 1220 is combined with the broadband signal produced by broadband coupling 1210 by means of low pass filter 1250 and high pass filter 1240, coupled either in series or, as shown in FIG. 12, in parallel. The combined zero crossing and broadband signal is then carried on a third wire, referenced to the ground wire of the DC output of the AC-DC module 310. The appliance 1245 contains a high pass filter and coupling circuitry 1270 to separate the broadband signal from the zero crossing signal and to convert the broadband data into a differential signal. Additionally a low pass filter 1280 is employed to extract the zero crossing signal from the combined zero crossing and broadband signal.

Circuitry described herein that performs particular functions may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions, which may be considered singularly or in combination a “processing module.” The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry including the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the FIGs. Such a memory device or memory element can be included in an article of manufacture.

The present invention has been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present invention may have also been described, at least in part, in terms of one or more embodiments. An embodiment of the present invention is used herein to illustrate the present invention, an aspect thereof, a feature thereof, a concept thereof, and/or an example thereof. A physical embodiment of an apparatus, an article of manufacture, a machine, and/or of a process that embodies the present invention may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present invention. A module includes a processing module, a functional block, hardware, and/or software stored on memory for performing one or more functions as may be described herein. Note that, if the module is implemented via hardware, the hardware may operate independently and/or in conjunction software and/or firmware. As used herein, a module may contain one or more sub-modules, each of which may be one or more modules.

While particular combinations of various functions and features of the present invention have been expressly described herein, other combinations of these features and functions are likewise possible. The present invention is not limited by the particular examples disclosed herein and expressly incorporates these other combinations.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the invention.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention.

1. An external power supply unit (PSU) for an appliance comprising:
rectification circuitry operable to convert an AC voltage from mains power lines to a DC voltage output;
decoupling circuitry operable to decouple a broadband data signal from the mains power lines;
timing circuitry operable to provide a signal representative of the mains AC voltage timing; and
conveyance circuitry operable to convey the DC voltage output, a ground reference signal, the signal representative of the mains AC voltage timing, and the broadband data signal to the appliance, wherein the conveyance circuitry comprises no more than four conductors.

2. The power supply unit of claim 1, wherein the timing circuitry comprises a zero-crossing detector.

3. The power supply unit of claim 1, wherein the timing circuitry is further operable to modulate the signal representative of the mains AC voltage timing onto either the DC voltage output or the broadband data signal.

4. The power supply unit of claim 3, wherein modulating of the DC output comprises causing the DC output to ripple between two levels at a frequency dependent on the signal representative of the mains AC voltage timing.

5. The power supply unit of claim 4, wherein the modulated DC voltage output and the ground reference are output on a pair of conductors of the conveyance circuitry.

6. The power supply unit of claim 3, wherein the conveyance circuitry comprises only the pair of conductors, the power supply unit being operable such that the broadband data signal, the modulated DC output, and the ground reference are all output on the same pair of conductors.

7. The power supply unit of claim 6, further comprising filtering circuitry operable to remove noise and/or raise output impedance of the circuitry operable to convert the mains AC voltage to at least one DC voltage and to allow the injection of the broadband data signal on the same pair of conductors as those operable to carry the modulated DC output and ground reference.

8. The power supply unit of claim 5, wherein the conveyance circuitry terminates with a conventional coaxial DC connector.

9. The power supply unit of claim 5, wherein the conveyance circuitry comprises a second pair of conductors operable to carry the broadband data signal.

10. The power supply unit of claim 3, wherein:
the signal representative of the mains AC voltage timing is modulated onto the DC voltage output to form a combined signal that is applied to a common mode of a coil tap transformer; and
two outputs of the coil tap transformer couple to respective conductors of the conveyance circuitry.

11. The power supply unit of claim 3, wherein the circuitry operable to modulate the DC voltage output with the signal representative of the mains AC voltage timing is operable to use a fixed reference and an oscillator, and feed an error amplifier operable to output an error signal for appropriate control of the duty cycle of the circuitry operable to converting a mains AC voltage to at least one DC voltage so as to modulate the DC output.

12. The power supply unit of claim 1, wherein the signal representative of the mains AC voltage timing is conveyed by modulation of a common mode voltage or current of the broadband data signal on a pair of conductors of the conveyance circuitry, the conveyance circuitry comprising a total of four conductors, the other two conductors being operable to convey the DC voltage output and ground reference signal.

13. The power supply unit of claim 1, wherein:
the conveyance circuitry comprises three conductors;
the DC voltage output is carried by a first conductor;
a ground reference is carried by a second conductor; and
the broadband data signal and signal representative of the mains AC voltage timing are carried by a third conductor.

14. An appliance requiring a DC power supply for operation comprising:
a power line communication modem operable to modulate and demodulate a broadband data signal onto mains electrical powerlines, the powerline communication modem operable based upon a mains timing signal;
a multi-line input operable to receive input signals conveyed thereto on two, or three conductors, the appliance being operable such that the input signals comprise the DC power supply, the broadband data signal, and the mains timing signal;
circuitry operable to obtain the mains timing signal; and
low pass filtering circuitry operable to separate the input signals into a DC component of the signal for supply of power.

15. The appliance of claim 14, further comprising a two-line input, high pass filtering circuitry, and circuitry operable to decouple the broadband data signal received at the multi-line input.

16. The appliance of claim 14, wherein the circuitry operable to obtain the mains timing signal comprises a band pass filter.

17. The appliance of claim 14, wherein the circuitry operable to obtain the mains timing signal comprises a divider circuit connected between two lines of the multi-line input, the two lines operable to carry the broadband data signal.

18. A method of conveying a DC voltage output and ground reference signal from a power supply unit to an appliance comprising:
in a first operation, conveying a signal representative of both a mains AC voltage timing and broadband data signal over no more than four conductors by modulating the signal representative of the mains AC voltage timing onto a DC voltage output; and
in a second operation, conveying a signal representative of both the mains AC voltage timing and the broadband data signal over no more than four conductors by modulating the signal representative of the mains AC voltage timing onto the broadband data signal.

19. The method of claim 18, further comprising:
carrying a modulated DC component of the DC voltage output as a common mode signal offset on a pair of conductors carrying the broadband data signal; and
carrying the ground reference on a third conductor.

20. The method of claim 18, further comprising modulating the DC voltage output with the signal representative of the mains AC voltage timing prior to coupling the modulated DC signal and a ground reference on a first pair of conductors.

21. The method of claim 20, further comprising coupling the broadband signal onto the first pair of conductors.
